(19) United States
(12) Patent Application Publication
(10) Pub. No.: US 2014/0055638 A1
(43) Pub. Date: Feb. 27, 2014

(54) PHOTOGRAPHING APPARATUS, METHOD OF CONTROLLING THE SAME, AND COMPUTER-READABLE RECORDING MEDIUM

(71) Applicant: SAMSUNG ELECTRONICS CO., LTD., Suwon-si (KR)

(72) Inventors: Sang-ryoon Son, Yongin-si (KR); Seon-ju Ahn, Yongin-si (KR); Seok-goun Lee, Seongnam-si (KR); Su-jung Park, Seoul (KR); Hyon-soo Kim, Yongin-si (KR); Kyung-soo Yoo, Suwon-si (KR)

(73) Assignee: SAMSUNG ELECTRONICS CO., LTD., Suwon-si (KR)

(21) Appl. No.: 13/955,470

(22) Filed: Jul. 31, 2013

(30) Foreign Application Priority Data
Aug. 27, 2012 (KR) 10-2012-0093891

(51) Int. Cl. H04N 5/235

(52) U.S. Cl. CPC H04N 5/2353
USPC 348/229.1

(57) ABSTRACT

A method of controlling a photographing apparatus is provided that includes: setting a first exposure time according to a user's input; determining a number of times photographing is performed according to an illuminance and the first exposure time; continuously capturing a plurality of still images the number of times photographing is performed; and generating a resultant image corresponding to the first exposure time by combining the captured plurality of still images.

### CROSS-REFERENCE TO RELATED PATENT APPLICATION

This application claims the benefit of Korean Patent Application No. 10-2012-0093891, filed on Aug. 27, 2012, in the Korean Intellectual Property Office, the disclosure of which is incorporated herein in its entirety by reference.

### BACKGROUND

1. Field

Disclosed herein is a photographing apparatus, a method of controlling the same, and a computer-readable recording medium having embodied thereon computer program codes for executing the method.

2. Description of the Related Art

A photographing apparatus captures an image by applying incident light passing through a lens, an iris, and so on, to an imaging device and performing photoelectric transformation. In this case, to make sure that the image is bright enough and to not cause saturation due to a high brightness value in the image, an iris value and an exposure time of the imaging device may be determined. A user may adjust brightness, depth, atmosphere, vividness, etc., of an image by adjusting an iris value and an exposure time. However, since there is a limit to a range of a photographing setting value for a user to determine, it is difficult for the user to capture a desired image.

### SUMMARY

Various embodiments of the invention may allow a user to easily capture a long exposure image, and may allow even a low specification photographing apparatus to capture a long exposure image.

According to an embodiment of the invention, there is provided a method of controlling a photographing apparatus, the method including: setting a first exposure time according to a user's input; determining a number of times photographing is performed according to an illuminance and the first exposure time; continuously capturing a plurality of still images the number of times photographing is performed; and generating a resultant image corresponding to the first exposure time by combining the captured plurality of still images.

Each of the plurality of still images may be captured for a second exposure time that is less than the first exposure time, and the number of times photographing is performed is determined according to the illuminance and an iris value.

The method may further include reducing brightness values of pixels of the plurality of still images to obtain reduced brightness values, wherein the generating of the resultant image includes combining the plurality of still images by summing the reduced brightness values.

The method may further include detecting a movement of the photographing apparatus, wherein the continuous capturing of the plurality of still images is performed only when there is no movement of the photographing apparatus or when the movement is less than a reference value.

The generating of the resultant image may include generating the resultant image by generating a combined image whenever each of the plurality of still images is input.

The method may further include reducing brightness values of pixels of the plurality of still images to obtain reduced brightness values, wherein the generating of the resultant image includes combining the plurality of still images having the reduced brightness values, wherein the reducing of the brightness values includes reducing the brightness values of the pixels of the plurality of still images such that contributions of the plurality of still images are the same and brightness values of pixels of the resultant image are not saturated.

The generating of the resultant image may include generating the combined image by calculating a brightness value Yₙ(x, y) of each pixel of the combined image according to the following equation when an input still image is an n^{th} (where 2≦n≦number of times photographing is performed, n is a natural number) still image,

$${Y}_{n} ( x , y ) = \frac{( n - 1 )}{n} \times {Y}_{n - 1} ( x , y ) + \frac{1}{n} \times {I}_{n} ( x , y )$$

where Yₙ(x, y) is a brightness value of each pixel with (x, y) coordinates of a combined image obtained by combining images from a first still image to an n^{th} still image, Yₙ₋₁(x, y) is a brightness value of each pixel with (x, y) coordinates of a combined image obtained by combining images from the first still image to an n-1^{th} still image, and Iₙ(x, y) is a brightness value of each pixel with (x, y) coordinates of the n^{th} still image.

According to another embodiment of the invention, there is provided a photographing apparatus including: a photographing unit that generates an image by performing photoelectric transformation on incident light; an exposure time setting unit that sets a first exposure time according to a user's input; a photographing control unit that determines a number of times photographing is performed according to an illuminance and the first exposure time, and controls the photographing unit to continuously capture a plurality of still images the number of times photographing is performed; and an image combining unit that generates a resultant image corresponding to the first exposure time by combining the captured plurality of still images.

Each of the plurality of still images may be captured for a second exposure time that is less than the first exposure time, and the number of times photographing is performed is determined according to the illuminance and an iris value.

The image combining unit may combine the plurality of still images by reducing brightness values of pixels of the plurality of still images to obtain reduced brightness values and summing the reduced brightness values.

The photographing apparatus may further include a movement detecting unit that detects a movement of the photographing apparatus, wherein the photographing control unit continuously captures the plurality of still images only when there is no movement of the photographing apparatus or when the movement is less than a reference value.

The image combining unit may generate the resultant image by generating a combined image whenever each of the plurality of still images is input.

The image combining unit may reduce brightness values of pixels of the plurality of still images to obtain reduced brightness values and combine the plurality of still images having the reduced brightness values, wherein the image combining unit reduces the brightness values such that contributions of the plurality of still images in the resultant image are the same and pixel values of pixels of the resultant image are not saturated.

The image combining unit may generate the combined image by calculating a brightness value of each pixel of the combined image according to the following equation when an input still image is an n^{th} (where 2≦n≦number of times photographing is performed, and n is a natural number) still image,

$${Y}_{n} ( x , y ) = \frac{( n - 1 )}{n} \times {Y}_{n - 1} ( x , y ) + \frac{1}{n} \times {I}_{n} ( x , y )$$

where Yₙ(x, y) is a brightness value of each pixel with (x, y) coordinates of a combined image obtained by combining images from a first still image to an n^{th} still image, Yₙ₋₁(x, y) is a brightness value of each pixel with (x, y) coordinates of a combined image obtained by combining images from the first still image to an n-1^{th} still image, and Iₙ(x, y) is a brightness value of each pixel with (x, y) coordinates of the n^{th} still image.

According to another embodiment of the invention, there is provided a non-transitory computer-readable recording medium having embodied thereon computer program codes for executing a method of controlling a photographing apparatus when being read and performed, the method including: setting a first exposure time according to a user's input; determining a number of times photographing is performed according to an illuminance and the first exposure time; continuously capturing a plurality of still images the number of times photographing is performed; and generating a resultant image corresponding to the first exposure time by combining the captured plurality of still images.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram illustrating a photographing apparatus according to an embodiment of the invention;

FIG. 2 is a block diagram illustrating a central processing unit/digital signal processor (CPU/DSP) and a photographing unit according to an embodiment of the invention;

FIG. 3 is a timing and block diagram for explaining a process of capturing a plurality of still images, according to an embodiment of the invention;

FIG. 4 is a pictorial view illustrating a plurality of still images and a resultant image according to an embodiment of the invention;

FIG. 5 is a pictorial view illustrating resultant images according to an embodiment of the invention;

FIG. 6 is a flowchart illustrating a method of controlling the photographing apparatus, according to an embodiment of the invention;

FIG. 7 is a flowchart illustrating a method of controlling the photographing apparatus, according to another embodiment of the invention;

FIG. 8 is a block diagram illustrating a CPU/DSP and the photographing unit according to another embodiment of the invention;

FIG. 9 is a flowchart illustrating a method of controlling a photographing apparatus, according to another embodiment of the invention; and

FIG. 10 is a pictorial view illustrating a user interface screen according to an embodiment of the invention.

### DETAILED DESCRIPTION

As used herein, the term “and/or” includes any and all combinations of one or more of the associated listed items.

The following description and the attached drawings are provided for better understanding of the invention, and descriptions of techniques or structures related to the invention which would be obvious to one of ordinary skill in the art will be omitted.

Various embodiments of the invention will now be described more fully with reference to the accompanying drawings, in which exemplary embodiments of the invention are shown. The invention may be embodied in many different forms and should not be construed as being limited to the embodiments set forth herein; rather, these embodiments are provided so that this disclosure will be thorough and complete, and will fully convey the concept of the invention to those of ordinary skill in the art.

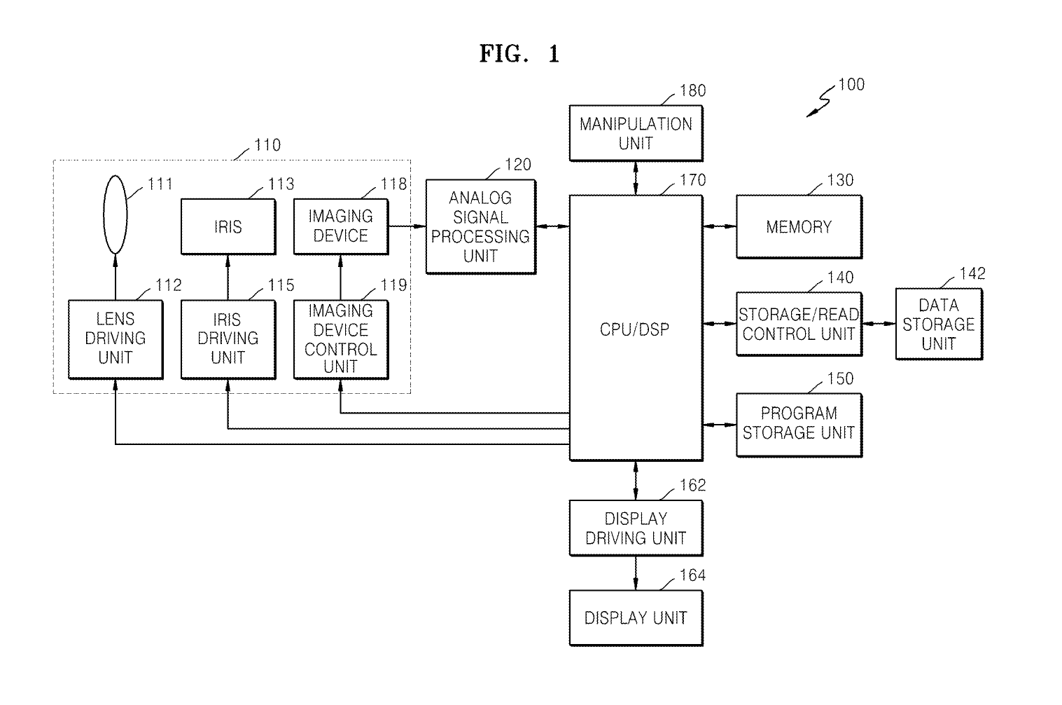

FIG. 1 is a block diagram illustrating a photographing apparatus 100 according to an embodiment of the invention.

The photographing apparatus 100 may include a photographing unit 110, an analog signal processing unit 120, a memory 130, a storage/read control unit 140, a data storage unit 142, a program storage unit 150, a display driving unit 162, a display unit 164, a central processing unit/digital signal processor (CPU/DSP) 170, and a manipulation unit 180.

An overall operation of the photographing apparatus 100 is controlled by the CPU/DSP 170. The CPU/DSP 170 applies control signals to the lens driving unit 112, the iris driving unit 115, and the imaging device control unit 119.

The photographing unit 110 which is an element for generating an image of an electrical signal from incident light includes a lens 111, the lens driving unit 112, an iris 113, the iris driving unit 115, an imaging device 118, and the imaging device control unit 119.

The lens 111 may include a plurality of groups of lenses or a plurality of lenses. A position of the lens 111 is adjusted by the lens driving unit 112. The lens driving unit 112 adjusts a position of the lens 111 according to a control signal applied by the CPU/DSP 170.

An extent to which the iris 113 is opened/closed is adjusted by the iris driving unit 115, and the iris 113 adjusts the amount of light incident on the imaging device 118.

An optical signal passing through the lens 111 and the iris 113 reaches a light-receiving surface of the imaging device 118 to form an image of a subject. The imaging device 118 may be a charge-coupled device (CCD) image sensor a complementary metal-oxide semiconductor image sensor (CIS) which converts the optical signal into an electrical signal, or any other similar imaging device. A sensitivity of the imaging device 118 may be adjusted by the imaging device control unit 119. The imaging device control unit 119 may control the imaging device 118 according to a control signal automatically generated by an image signal input in real time or a control signal manually input by a user's manipulation.

An exposure time of the imaging device 118 is adjusted by a shutter (not shown). The shutter may be a mechanical shutter that adjusts incidence of light by moving the iris 113 or an electronic shutter that adjusts exposure by applying an electrical signal to the imaging device 118.

The analog signal processing unit 120 performs noise reduction, gain adjustment, waveform shaping, analog-to-digital conversion, etc., on an analog signal applied from the imaging device 118.

The analog signal processed by the analog signal processing unit 120 may be input to the CPU/DSP 170 through the memory 130, or may be directly input to the CPU/DSP 170 without passing through the memory 130. The memory 130 functions as a main memory of the photographing apparatus 100 and temporarily stores necessary information during an operation of the CPU/DSP 170. The program storage unit 150 stores programs including an operation system, an application system, and so on for driving the digital photographing apparatus 100.

In addition, the photographing apparatus 100 includes the display unit 164 that displays information about an image obtained by the photographing apparatus 100 or an operating state of the photographing apparatus 100. The display unit 164 may provide visual information and/or acoustic information to the user. In order to provide the visual information, the display unit 164 may include, for example, a liquid crystal display (LCD) panel or an organic light-emitting display panel. Alternatively, the display unit 164 may be a touchscreen that may recognize a touch input.

The display driving unit 162 applies a driving signal to the display unit 164.

The CPU/DSP 170 processes an image signal input thereto, and controls each element according to the image signal or an external input signal. The CPU/DSP 170 may perform image signal processing such as noise reduction, gamma correction, color filter array interpolation, color matrix, color correction, or color enhancement on input image data to improve image quality. Also, the CPU/DSP 170 may generate an image file by compressing image data generated by performing the image signal processing for improving image quality, or may restore image data from the image file. An image compression format may be reversible or irreversible. In the case of a still image, examples of the image compression format may include a joint photographic experts group (JPEG) format and a JPEG 2000 format. Also, in the case where a moving picture is recorded, a moving picture file may be generated by compressing a plurality of frames according to the moving picture experts group (MPEG) standard. The image file may be generated according to, for example, the exchangeable image file format (Exif) standard.

The image data output from the CPU/DSP 170 is input to the storage/read control unit 140 directly or through the memory 130, and the storage/read control unit 140 stores the image data in the data storage unit 142 automatically or according to a signal from the user. Also, the storage/read control unit 140 may read data about an image from an image file stored in the data storage unit 142, and may input the data to the display driving unit 162 through the memory 130 or another path to display the image on the display unit 164. The data storage unit 142 may be detachably attached to the photographing apparatus 100 or may be permanently attached to the photographing apparatus 100.

Also, the CPU/DSP 170 may perform color processing, blur processing, edge emphasis, image analysis, image recognition, image effect processing, and so on. Examples of the image recognition may include face recognition and scene recognition. In addition, the CPU/DSP 170 may perform display image signal processing for displaying the image on the display unit 164. For example, the CPU/DSP 170 may perform brightness level adjustment, color correction, contrast adjustment, contour emphasis, screen splitting, character image generation, and image synthesis. The CPU/DSP 170 may be connected to an external monitor, may perform predetermined image signal processing to display the image on the external monitor, and may transmit processed image data to display a corresponding image on the external monitor.

Also, the CPU/DSP 170 may generate a control signal for controlling auto-focusing, zoom change, focus change, auto-exposure correction, and so on by executing a program stored in the program storage unit 130 or by including a separate module and may provide the control signal to the iris driving unit 115, the lens driving unit 112, and the imaging device control unit 119 to control operations of elements included in the photographing apparatus 100 such as a shutter and a strobe.

The manipulation unit 180 is an element through which the user may input a control signal. The manipulation unit 180 may include various functional buttons such as a shutter-release button for inputting a shutter-release signal by exposing the imaging device 118 to light for a predetermined period of time to take a photograph, a power button for inputting a control signal to control power on/off, a zoom button for widening or narrowing a viewing angle according to an input, a mode selection button, and a photographing setting value adjustment button. The manipulation unit 180 may be embodied as any of various forms that allow the user to input a control signal such as buttons, a keyboard, a touch pad, a touchscreen, and a remote controller.

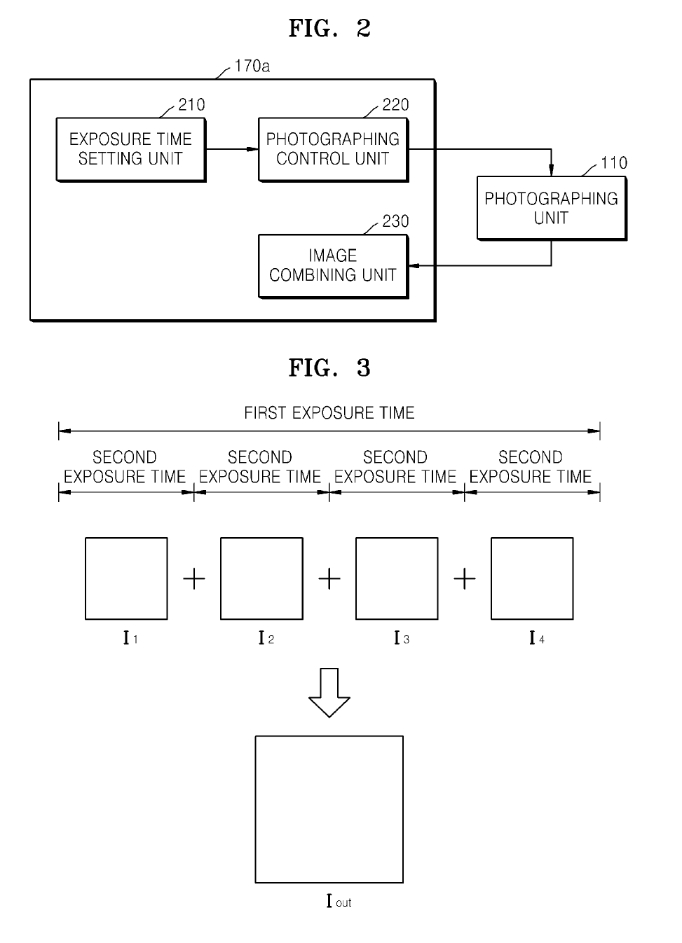

FIG. 2 is a block diagram illustrating a CPU/DSP 170a and the photographing unit 110 according to an embodiment of the invention.

Referring to FIG. 2, the CPU/DSP 170a includes an exposure time setting unit 210, a photographing control unit 220, and an image combining unit 230.

The exposure time setting unit 210 sets a first exposure time that is a total exposure time of a resultant image according to the user's input. In the present embodiment, the user may set the first exposure time that is greater than a maximum exposure time allowed by the photographing apparatus 100. In the present embodiment, the user may photograph a subject, for example, a waterfall, a fountain, bubbles, a firework, a night scene, or stars, for an exposure time greater than an exposure time allowed by the photographing apparatus 100 to show all tracks of the subject. For example, even when a maximum exposure time allowed by the photographing apparatus 100 is 1 second, the user may set the first exposure time to 5 seconds. The user may set the first exposure time in various ways. For example, the user may directly set the first exposure time or indirectly set the first exposure time to be long, medium, and short. Also, the user may give an input through the manipulation unit 180.

In the present embodiment, long exposure photographing may be performed in a specific mode that may be set by the photographing apparatus 100. When the photographing apparatus 100 is set to a specific mode, the exposure time setting unit 210 may provide a user interface through which the user may set the first exposure time.

The photographing control unit 220 determines a number of times photographing is performed according to an illuminance and the first exposure time. Also, the photographing control unit 220 controls the photographing unit 110 to continuously capture a plurality of still images, and the determined number of times photographing is performed.

FIG. 3 is a diagram for explaining a process of capturing a plurality of still images, according to an embodiment of the invention.

The first exposure time is set by the exposure time setting unit 210 according to the user's input as described above. The photographing control unit 220 controls the photographing unit 110 to continuously capture a plurality of still images in order to generate a resultant image corresponding to the first exposure time. To this end, the photographing control unit 220 determines a number of times photographing is performed for the first exposure time. For example, the photographing control unit 220 may determine a range of an exposure time needed to capture each still image according to the illuminance and may determine a number of times photographing is performed according to the determined range of the exposure time. A second exposure time for which each still image is exposed may be determined by dividing the first exposure time by the number of times photographing is performed.

In the present embodiment, the number of times photographing is performed is determined according to the illuminance and the first exposure time. A range of an exposure time needed to capture each image according to the illuminance may be determined and the number of times photographing is performed may be determined. Also, the number of times photographing is performed may be determined in consideration of both the illuminance and an iris value.

Once the number of times photographing is performed and the second exposure time are determined, the photographing control unit 220 controls the photographing unit 110 to continuously capture the plurality of still images, and the number of times photographing is performed. The plurality of still images may be captured in various ways. For example, the plurality of still images may be captured in response to a shutter-release signal, may be captured when there is no movement of the photographing apparatus 100, or may be captured with a timer.

Also, the photographing control unit 220 may control an operation of capturing the plurality of still images according to a type of a shutter included in the photographing unit 110. For example, when the shutter is a mechanical shutter that blocks incident light by moving a blade, the photographing control unit 220 controls the photographing unit 110 to capture the plurality of still images at time intervals according to a movement of the shutter and reads out the captured images. Alternatively, when the shutter is an electronic shutter such as a rolling shutter which controls an exposure time by using an electronic film, the photographing control unit 220 may control the electronic film to continuously capture the plurality of still images.

The photographing unit 110 continuously captures the plurality of still images, and the number of times photographing is performed for the second exposure time under the control of the photographing control unit 220. Also, the photographing unit 110 applies the captured plurality of still images to the image combining unit 230.

The image combining unit 230 generates a resultant image corresponding to the first exposure time by combining the plurality of still images. Referring to FIG. 3, when a still image is continuously captured 4 times in order to capture a resultant image Iₒᵤₜ corresponding to the first exposure time, a plurality of still images I₁, I₂, I₃, and I₄ are generated by the photographing unit 110. The image combining unit 230 generates the resultant image Iₒᵤₜ by combining the plurality of still images I₁, I₂, I₃, and I₄. In the present embodiment, the resultant image Iₒᵤₜ may be an image generated by summing brightness values of pixels of the plurality of still images I₁, I₂, I₃, and I₄ through linear combination. When the brightness values of the pixels of the plurality of still images I1, I2, I3, and I4 are summed up, saturation may occur due to high brightness values of pixels of the resultant image lout thereby not displaying the subject or reducing contrast. In the present embodiment, however, when the brightness values of the pixels of the plurality of still images I1, I2, I3, and I4 are summed through linear combination, in order not to saturate the brightness values of the pixels of the resultant image Iₒᵤₜ, linear combination may be performed by adjusting weights applied to the brightness values of the pixels of the plurality of still images I₁, I₂, I₃, and I₄. For example, when the number of times photographing is performed is 4, the resultant image Iₒᵤₜ may be generated by multiplying the brightness values of the pixels of the still images I₁, I₂, I₃, and I₄ by ¼ to obtain reduced brightness values and summing the reduced brightness values.

In the present embodiment, when a mechanical shutter is used, the image combining unit 230 may combine the plurality of still images by correcting a global motion generated due to the mechanical shutter.

In the present embodiment, the user may obtain a resultant image having an exposure time greater than a maximum exposure time which the user may set. Also, even when long exposure photographing is performed by mounting a filter or the like on a lens barrel, the maximum exposure time which the user may set has a limitation and an additional accessory is needed. In the present embodiment, however, long exposure photographing may be performed without mounting an additional accessory. Also, in the present embodiment, even when the user is inexperienced in manipulating the photographing apparatus 100, the user may easily perform long exposure photographing.

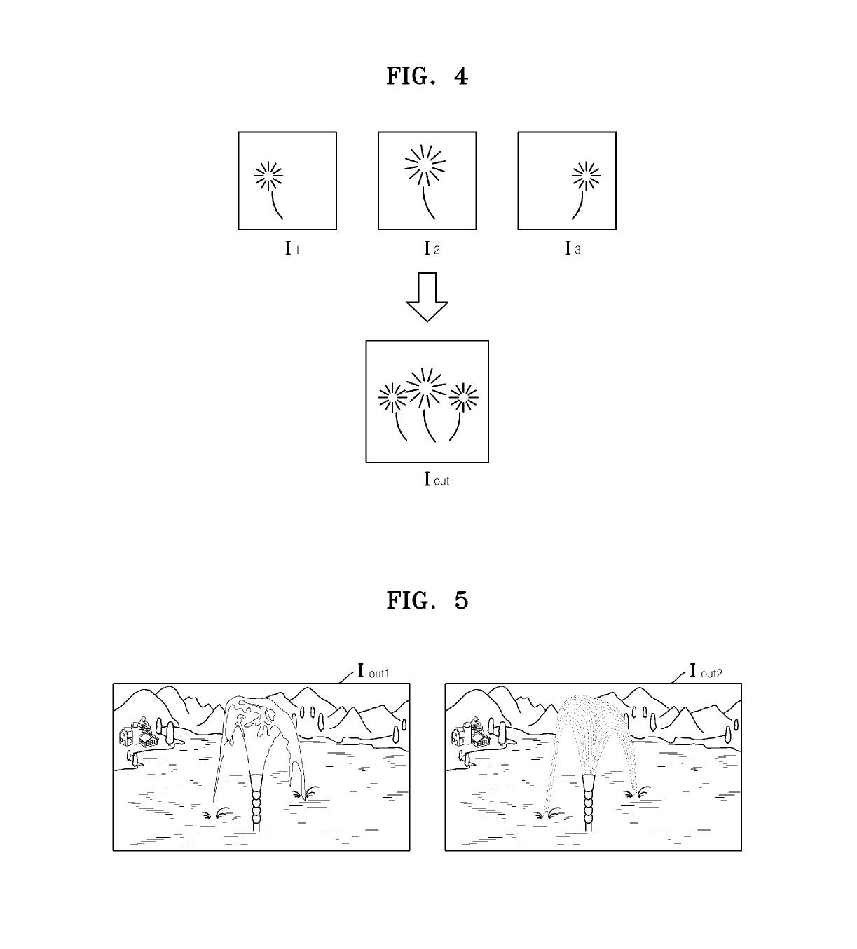

FIG. 4 is a view illustrating the resultant image Iₒᵤₜ and the plurality of still images I₁, I₂, and I₃, according to an embodiment of the invention. In the present embodiment, the resultant image Iₒᵤₜ which is a long exposure image may be generated by continuously photographing a firework to obtain the plurality of still images I₁, I₂, and I₃.

FIG. 5 is a view illustrating resultant images Iₒᵤₜ₁ and Iₒᵤₜ₂ according to an embodiment of the invention. The user may adjust effects of the resultant images Iₒᵤₜ₁ and Iₒᵤₜ₂ by adjusting the first exposure time. For example, the resultant image Iₒᵤₜ₂ of FIG. 5 is obtained by setting the first exposure time to be greater than that of the resultant image Iₒᵤₜ₁. As shown in FIG. 5, effects of tracks along which objects move vary according to the first exposure time.

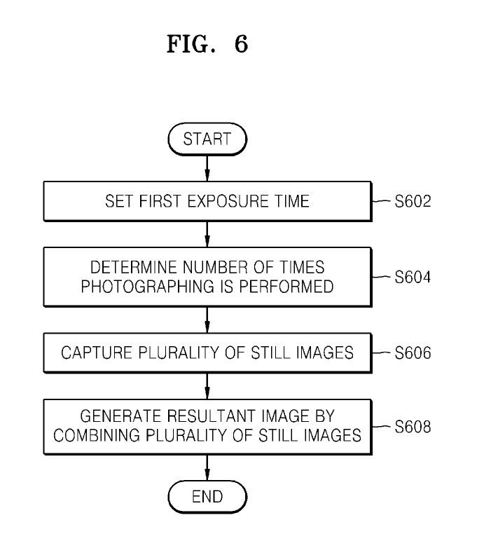

FIG. 6 is a flowchart illustrating a method of controlling the photographing apparatus 100, according to an embodiment of the invention.

Referring to FIG. 6, in operation S602, a first exposure time is set according to the user's input. In FIG. 6, the first exposure time may be set only when the photographing apparatus is set to a specific mode.

In operation S604, a number of times photographing is performed to obtain a plurality of still images is determined according to an illuminance. In FIG. 6, the number of times photographing is performed may be set in consideration of the illuminance and an iris value. Also, a second exposure time applied to each of the plurality of still images is determined according to the number of times photographing is performed.

Next, in operation S606, the plurality of still images are continuously captured, and the number of times photographing is performed. Each of the plurality of still images is captured for the second exposure time.

In operation S608, a resultant image corresponding to the first exposure time is generated by combining the plurality of still images. The resultant image may be generated by summing brightness values of pixels of the plurality of still images through linear combination. In this case, the brightness values of the pixels of the plurality of still images may be linearly combined so as not to saturate brightness values of pixels of the resultant image.

Alternatively, whenever a still image is input from the photographing unit 110, the image combining unit 230 may combine a current stored combined image with the input still image. In the present embodiment, since only one combined image and one still image are temporarily stored in the memory 130 without temporarily storing all of the plurality of still images, a space of the memory 130 may be saved. Also, even the photographing apparatus 100 having a limited space of the memory 130 may capture a long exposure image.

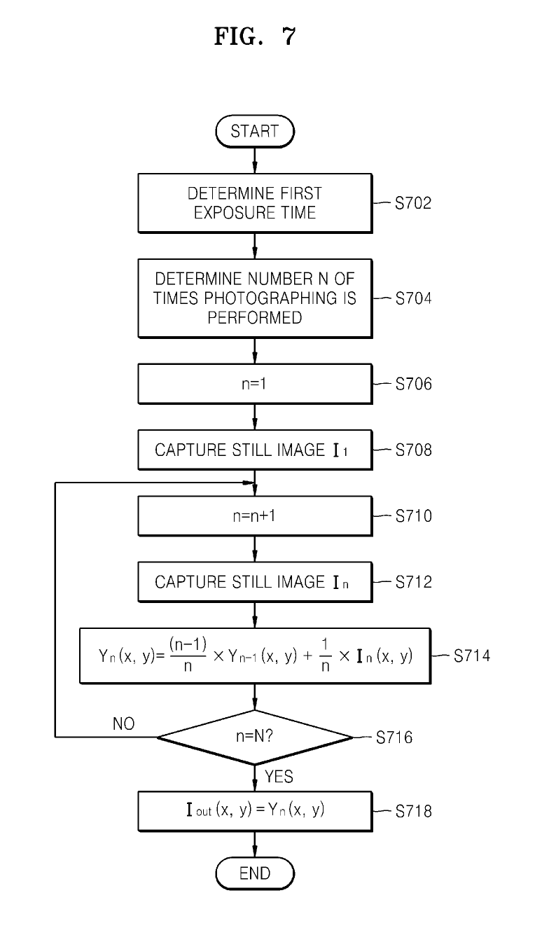

FIG. 7 is a flowchart illustrating a method of controlling the photographing apparatus 100, according to another embodiment of the invention.

In operation S702, a first exposure time is determined according to the user's input. In operation S704, a number of times N photographing is performed to obtain continuously captured still images is determined according to an illuminance and the first exposure time. Next, in operation S706, a variable n indicating a current number of times photographing is performed is set to 1. In operation S708, a first still image I₁ is captured. In operation S710, the variable n is increased by 1. In operation S712, a second still image I₂ is captured. In operation S714, a combined image Yₙ is generated according to Equation 1.

$${Y}_{n} ( x , y ) = \frac{( n - 1 )}{n} \times {Y}_{n - 1} ( x , y ) + \frac{1}{n} \times {I}_{n} ( x , y ) , \qquad ( 1 )$$

where Yₙ(x, y) indicates a brightness value of each pixel of the combined image Yₙ, Yₙ₋₁(X, y) indicates a brightness value of each pixel of a currently stored combined image obtained by combining still images from the first still image i₁ to an n-1^{th} still image Iₙ, and Iₙ(x, y) indicates a brightness value of each pixel of a still image input from the photographing unit 110.

In operation S716, it is determined whether the variable n is equal to the number of times N photographing is performed. Operations S710, S712, and S714 are repeatedly performed until an N^{th} input image I_{N} is input and a combined image Y_{N} is generated. In operation S718, when the N^{th} input image I_{N} is input and the combined image Y_{N} is generated, a resultant image Iₒᵤₜ may be obtained.

For example, when a total number of times N photographing is performed is 4, a resultant image Iₒᵤₜ is generated as shown by Equation 2.

Y₂(x,y)=½×I₁(x,y)+½×I₂(x,y)

Y₃(x,y)=⅔×Y₂(x,y)+⅓×I₃(x,y)

Y₄(x,y)=¾×Y₃(x,y)+¼×I₄(x,y)

and

Iₒᵤₜ(x,y)=Y₄(x,y) (2).

In the present embodiment, a combined image may be generated whenever a still image is input, and contributions of a plurality of still images in a resultant image may be the same. The earlier an image is captured and input, the more image combination processes the image undergoes. In the present embodiment, contributions of a plurality of still images in a resultant image may be the same by making a weight applied to an existing combined image greater than or equal to a weight applied to an input still image.

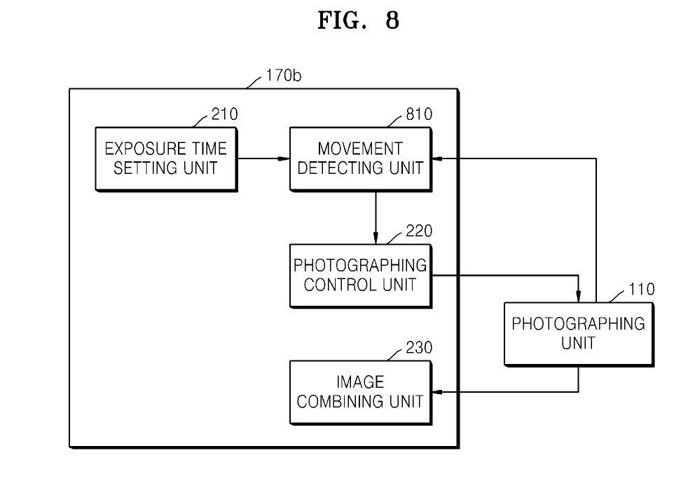

FIG. 8 is a block diagram illustrating a CPU/DSP 170b and the photographing unit 110 according to another embodiment of the invention. Referring to FIG. 8, the CPU/DSP 170b may include the exposure time setting unit 210, the photographing control unit 220, the image combining unit 230, and a movement detecting unit 810.

In the present embodiment, only when there is no movement of the photographing apparatus 100, may long exposure photographing be performed. Long exposure photographing may be effectively performed when there is no movement of the photographing apparatus 100 and only a specific subject moves. Accordingly, when there is a movement of the photographing apparatus 100, it is difficult to obtain a long exposure image having a desired effect. In the present embodiment, since a plurality of still images are captured only when there is no movement of the photographing apparatus 100 or a movement is less than a reference value, a resultant image desired by the user may be obtained.

In the present embodiment, the movement detecting unit 810 detects whether there is a movement of the photographing apparatus 100.

For example, the movement detecting unit 810 may be embodied as a sensor (e.g., a gyro sensor) that directly detects a movement of the photographing apparatus 100. In this case, the movement detecting unit 810 may be disposed outside the CPU/DSP 170b, unlike in FIG. 8.

Alternatively, the movement detecting unit 810 may detect a movement of the photographing apparatus 100 from an image input from the photographing unit 110. The image input from the photographing unit 110 may be, for example, a live-view image.

In the present embodiment, the photographing control unit 220 may continuously capture a plurality of still images only when the movement detecting unit 810 determines that there is no movement of the photographing apparatus 100 or a movement is less than a reference value.

For example, when it is determined that there is no movement or a movement is less than a reference value, the photographing apparatus 100 may enter a specific mode in which long exposure photographing is performed.

Alternatively, the photographing control unit 220 may continuously capture a plurality of still images only when it is determined that there is no movement or a movement is less than a reference value. In this case, even when a shutter-release signal is input, if a movement is equal to or greater than a predetermined value, the photographing control unit 220 may not capture a plurality of still images. For example, the photographing control unit 220 may automatically capture a plurality of still images when a movement is equal to or less than a predetermined value.

In the present embodiment, the image combining unit 230 may combine a plurality of still images by correcting a global motion due to a movement generated in the plurality of still images according to movement information obtained by the movement detecting unit 810.

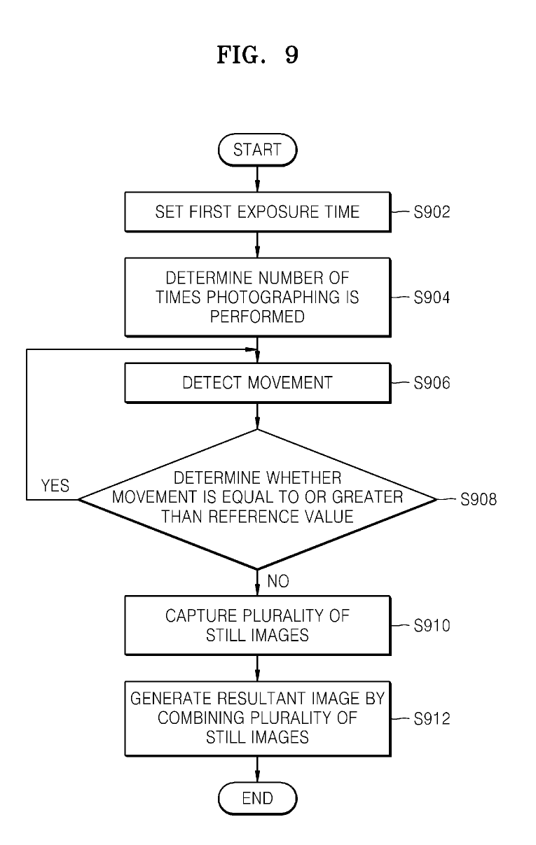

FIG. 9 is a flowchart illustrating a method of controlling the photographing apparatus 100, according to another embodiment of the invention.

Referring to FIG. 9, in operation S902, a first exposure time is determined. In operation S904, a number of times photographing is performed is determined according to an illuminance and the first exposure time.

In operation S906, a movement of the photographing apparatus 100 is detected. In operation S908, it is determined whether the movement is equal to or greater than a reference value. In the present embodiment, determination may be performed in various ways. For example, it may be determined whether there is a movement or a movement is equal to or less than a reference value.

When it is determined in operation S908 that the movement is equal to or greater than the reference value, the plurality of still images are not captured. When it is determined in operation S908 that the movement is less than the reference value, the method proceeds to operation S910. In operation S910, the plurality of still images are captured for a second exposure time the determined number of times photographing is performed. Next, in operation S912, a resultant image corresponding to the first exposure time is generated by combining the plurality of still images.

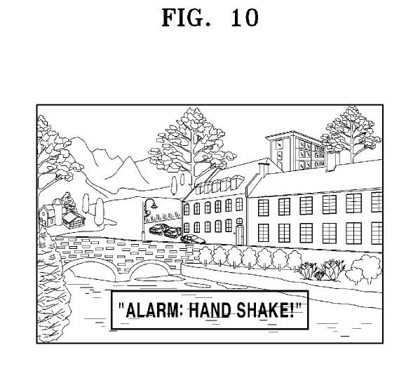

FIG. 10 is a view illustrating a user interface screen according to an embodiment of the invention.

Referring to FIG. 10, when a movement is equal to or greater than a predetermined value, the movement detecting unit 810 or the photographing control unit 220 may output to the user an alarm message through the display unit 164, a warning light, or a sound. For example, the movement detecting unit 810 or the photographing control unit 220 may display an alarm message on the user interface screen as shown in FIG. 10.

According to the one or more embodiments, a user may easily capture a long exposure image.

Also, according to the one or more embodiments, even a low specification photographing apparatus may capture a long exposure image.

The apparatus described herein may include a processor, a memory for storing program data and executing it, a permanent storage unit such as a disk drive, a communication port for handling communications with external devices, and user interface devices, etc. Any processes may be implemented as software modules or algorithms, and may be stored as program instructions or computer readable codes executable by a processor on computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the exemplary embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that are executed on one or more processors. Furthermore, the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention.

While the invention has been particularly shown and described with reference to exemplary embodiments thereof by using specific terms, the embodiments and terms have merely been used to explain the invention and should not be construed as limiting the scope of the invention as defined by the claims. The exemplary embodiments should be considered in a descriptive sense only and not for purposes of limitation. Therefore, the scope of the invention is defined not by the detailed description of the invention but by the appended claims, and all differences within the scope will be construed as being included in the invention.

What is claimed is:

1. A method of controlling a photographing apparatus, the method comprising:
setting a first exposure time according to a user's input;
determining a number of times photographing is performed according to an illuminance and the first exposure time;
continuously capturing a plurality of still images the number of times photographing is performed; and
generating a resultant image corresponding to the first exposure time by combining the captured plurality of still images.

2. The method of claim 1, further comprising:
capturing each of the plurality of still images for a second exposure time that is less than the first exposure time, and
determining the number of times photographing is performed according to the illuminance and an iris value.

3. The method of claim 1, further comprising:
reducing brightness values of pixels of the plurality of still images to obtain reduced brightness values,
wherein the generating of the resultant image comprises combining the plurality of still images by summing the reduced brightness values.

4. The method of claim 1, further comprising:
detecting a movement of the photographing apparatus,
wherein the continuous capturing of the plurality of still images is performed only when there is no movement of the photographing apparatus or when the movement is less than a reference value.

5. The method of claim 1, wherein the generating of the resultant image comprises generating the resultant image by generating a combined image whenever each of the plurality of still images is input.

6. The method of claim 5, further comprising:
reducing brightness values of pixels of the plurality of still images to obtain reduced brightness values,
wherein
the generating of the resultant image comprises combining the plurality of still images having the reduced brightness values, and
the reducing of the brightness values comprises reducing the brightness values of the pixels of the plurality of still images such that contributions of the plurality of still images are the same and brightness values of pixels of the resultant image are not saturated.

7. The method of claim 5, wherein the generating of the resultant image comprises generating the combined image by calculating a brightness value Yₙ(x, y) of each pixel of the combined image according to the following equation when an input still image is an n^{th} (where 2≦n≦number of times photographing is performed, and n is a natural number) still image,
$${Y}_{n} ( x , y ) = \frac{( n - 1 )}{n} \times {Y}_{n - 1} ( x , y ) + \frac{1}{n} \times {I}_{n} ( x , y )$$
where:
Yₙ(x, y) is a brightness value of each pixel with (x, y) coordinates of a combined image obtained by combining images from a first still image to an n^{th} still image,
Yₙ₋₁(x, y) is a brightness value of each pixel with (x, y) coordinates of a combined image obtained by combining images from the first still image to an n-1^{th} still image, and
Iₙ(x, y) is a brightness value of each pixel with (x, y) coordinates of the n^{th} still image.

8. A photographing apparatus comprising:
a photographing unit that generates an image by performing photoelectric transformation on incident light;
an exposure time setting unit that sets a first exposure time according to a user's input;
a photographing control unit that determines a number of times photographing is performed according to an illuminance and the first exposure time, and controls the photographing unit to continuously capture a plurality of still images the number of times photographing is performed; and
an image combining unit that generates a resultant image corresponding to the first exposure time by combining the captured plurality of still images.

9. The photographing apparatus of claim 8, wherein each of the plurality of still images is captured for a second exposure time that is less than the first exposure time,
and the number of times photographing is performed is determined according to the illuminance and an iris value.

10. The photographing apparatus of claim 8, wherein the image combining unit combines the plurality of still images by reducing brightness values of pixels of the plurality of still images to obtain reduced brightness values and summing the reduced brightness values.

11. The photographing apparatus of claim 8, further comprising:
a movement detecting unit that detects a movement of the photographing apparatus,
wherein the photographing control unit continuously captures the plurality of still images only when there is no movement of the photographing apparatus or when the movement is less than a reference value.

12. The photographing apparatus of claim 8, wherein the image combining unit generates the resultant image by generating a combined image whenever each of the plurality of still images is input.

13. The photographing apparatus of claim 12, wherein:
the image combining unit reduces brightness values of pixels of the plurality of still images to obtain reduced brightness values and combines the plurality of still images having the reduced brightness values, and
the image combining unit reduces the brightness values such that contributions of the plurality of still images in the resultant image are the same and pixel values of pixels of the resultant image are not saturated.

14. The photographing apparatus of claim 12, wherein the image combining unit generates the combined image by calculating a brightness value of each pixel of the combined image according to the following equation when an input still image is an n^{th} (where 2≦n≦number of times photographing is performed, and n is a natural number) still image,
$${Y}_{n} ( x , y ) = \frac{( n - 1 )}{n} \times {Y}_{n - 1} ( x , y ) + \frac{1}{n} \times {I}_{n} ( x , y )$$
where
Yₙ(x, y) is a brightness value of each pixel with (x, y) coordinates of a combined image obtained by combining images from a first still image to an n^{th} still image,
Yₙ₋₁(x, y) is a brightness value of each pixel with (x, y) coordinates of a combined image obtained by combining images from the first still image to an n-1^{th} still image, and
Iₙ(x, y) is a brightness value of each pixel with (x, y) coordinates of the n^{th} still image.

15. A non-transitory computer-readable recording medium having embodied thereon computer program codes for executing a method of controlling a photographing apparatus when being read and performed, the method comprising:
setting a first exposure time according to a user's input;
determining a number of times photographing is performed according to an illuminance and the first exposure time;
continuously capturing a plurality of still images the number of times photographing is performed; and
generating a resultant image corresponding to the first exposure time by combining the captured plurality of still images.

16. The non-transitory computer-readable recording medium of claim 15, wherein:
each of the plurality of still images is captured for a second exposure time that is less than the first exposure time, and
the number of times photographing is performed is determined according to the illuminance and an iris value.

17. The non-transitory computer-readable recording medium of claim 15, wherein the method further comprises:
reducing brightness values of pixels of the plurality of still images to obtain reduced brightness values,
wherein the generating of the resultant image comprises combining the plurality of still images by summing the reduced brightness values.

18. The non-transitory computer-readable recording medium of claim 15, wherein the method further comprises:
detecting a movement of the photographing apparatus,
wherein the continuous capturing of the plurality of still images is performed only when there is no movement of the photographing apparatus or when the movement is less than a reference value.

19. The non-transitory computer-readable recording medium of claim 15, wherein the generating of the resultant image comprises generating the resultant image by generating a combined image whenever each of the plurality of still images is input.

20. The non-transitory computer-readable recording medium of claim 19, wherein the generating of the resultant image comprises generating the combined image by calculating a brightness value Yₙ(x, y) of each pixel of the combined image according to the following equation when an input still image is an n ^{th} (where 2≦n≦number of times photographing is performed, and n is a natural number) still image,
$${Y}_{n} ( x , y ) = \frac{( n - 1 )}{n} \times {Y}_{n - 1} ( x , y ) + \frac{1}{n} \times {I}_{n} ( x , y )$$
where
Yₙ(x, y) is a brightness value of each pixel with (x, y) coordinates of a combined image obtained by combining images from a first image to an n^{th} still image,
Yₙ₋(X, y) is a brightness value of each pixel with (x, y) coordinates of a combined image obtained by combining images from the first image to an n-1^{th} still image, and
Iₙ(x, y) is a brightness value of each pixel with (x, y) coordinates of the n^{th} still image.
